(19) United States
(12) Patent Application Publication
(10) Pub. No.: US 2010/0134267 A1
(43) Pub. Date: Jun. 3, 2010

(54) VEHICLE WARNING SYSTEM AND METHOD

(75) Inventor: Chun-Cheng LIN, Hsinchu City (TW)

Correspondence Address: EGBERT LAW OFFICES, 412 MAIN STREET, 7TH FLOOR, HOUSTON, TX, 77002, US

(73) Assignee: National Chin-Yi University of Technology, Taiping City (TW)

(21) Appl. No.: 12/327,706

(22) Filed: Dec. 3, 2008

(51) Int. Cl. B60Q 1/00

(52) U.S. Cl. 340/441

(57) ABSTRACT

The present invention provides a vehicle speed warning system and method for acquiring the images thereof. There is a speedometer image acquisition device, mounted correspondingly to the speedometer of the existing panel, and used to acquire the images of the speedometer. An image converter converts the images acquired by a speedometer image acquisition device into digital image data. A processor is used to receive digital image data and analyze the rotating angle of the pointer of speedometer. A memory stores the program of the vehicle speed warning system and digital image data of the speedometer. A display screen displays the speed value and/or the judgment result analyzed by the processor. The setting unit sets the warning threshold of the pointer angle of speedometer. A warning device, used to send a warning signal when the pointer angle of the speedometer exceeds the warning threshold set by the driver.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a vehicle speed warning system and method, and more particularly to an innovative system and method to acquire and automatically judge the speedometer images and to give a warning to the drivers.

2. Description of Related Art Including Information Disclosed Under 37 CFR 1.97 and 37 CFR 1.98

When driving a car along a common road or highway, the driver may find it difficult to concentrate attention on the speed all the way, so speeding often occurs unconsciously, leading to possible speeding fines and driving hazards.

As a general rule, an expensive vehicle is always equipped with a “vehicle speed warning system”, allowing the driver to set the maximum speed and to view the digital speed data provided by an onboard computer system. When maximum speed is exceeded, the vehicle speed warning system will automatically send a warning sound or audible signal to the driver.

However, most onboard computer systems are not available with digital speed data. If a vehicle speed warning system is to be installed as required by the customers, an interface for converting analog speed signals into digital signals is required. Moreover, when the vehicle speed warning system is installed, the faceplate of vehicle must be dismantled to acquire the speed signals in the panel, resulting in higher complexity and cost of installation.

A speed warning device has been developed, which acquires roadside images and judges the figures about traffic signs, then compares such information with the vehicle speed to order to give a warning automatically. However, it is observed from actual experience that acquisition of roadside images has problems, such as poor definition of images, instability and disruption caused by bad weather as well as obstacles in the nighttime. As the vehicle moves forward, the surroundings inside and outside lanes change quickly, and the image acquisition is often blocked off by other running vehicles, leading to a poor warning effect.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The speed warning system and method disclosed by the present invention gives a warning signal by acquiring the images of the speedometer. It has the advantage of lower complexity in image processing; meanwhile no high-performance micro-processor is required. Thus, it can really reduce the manufacturing cost and bring about desirable economic benefits.

The present invention enables automatic judgment and warning by acquiring the images of the speedometer. The speedometer is mounted at a fixed position on the vehicle, so the speedometer image acquisition device is intended for acquiring a rather stable object and obtaining images of high definition, irrespective of bad weather or during nighttime. So, the present invention can give extremely accurate warning signals in an effective and efficient way.

The other advantage of the vehicle speed warning system of the present invention is that the speed warning signal can be sent without changing the existing framework of the vehicle; thus, it is a preferred option for the drivers.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view preferred embodiment of the vehicle speed warning system of the present invention.

FIG. 2 is a schematic view of a block diagram showing the operational relationship of various units of vehicle speed warning system of the present invention.

FIG. 3 is a schematic view of a text block diagram of the first preferred embodiment of the present invention showing the speed judgment method.

FIG. 4 is a schematic view of the second preferred embodiment of the present invention showing the speed judgment method.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

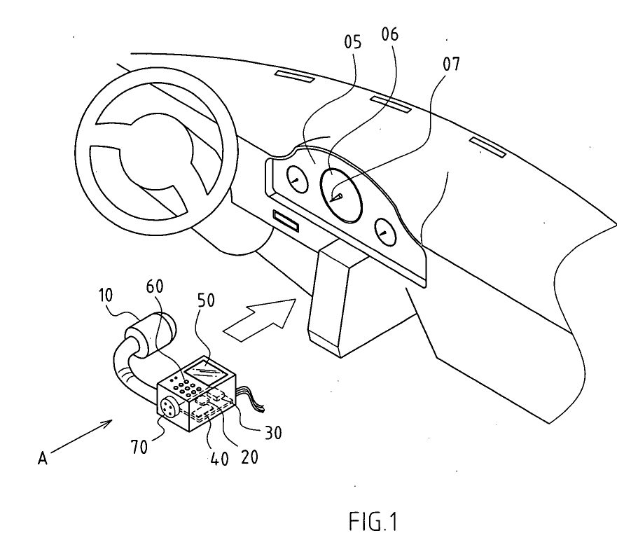

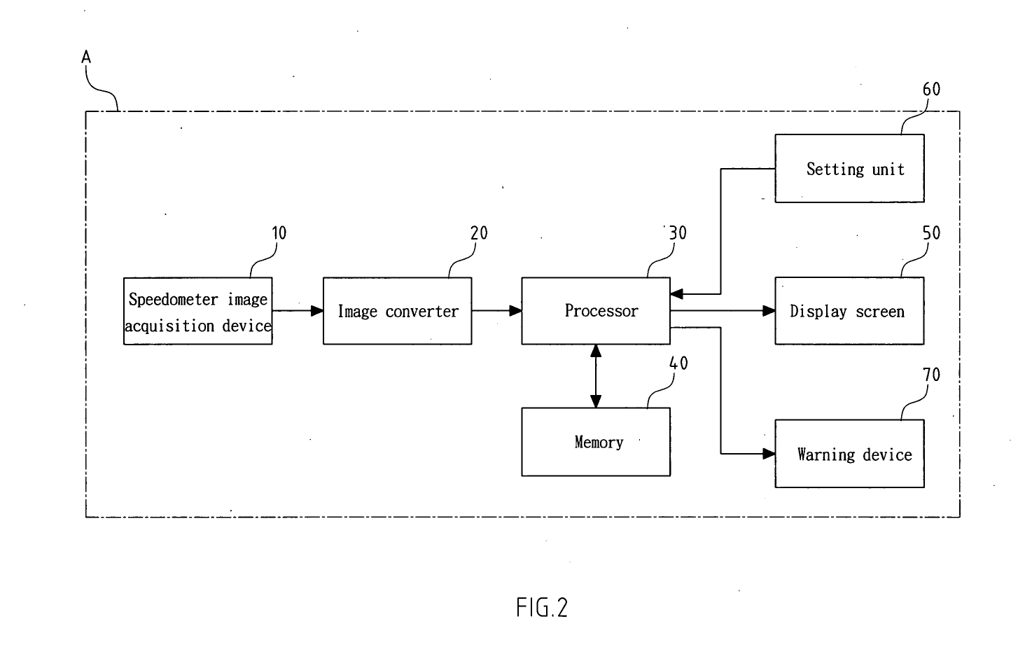

FIGS. 1-2 depict preferred embodiments of vehicle speed warning system and method of the present invention. The embodiments are only provided for explanatory purposes with respect to the patent claims.

The vehicle speed warning system A comprises a speedometer image acquisition device 10, mounted correspondingly to the speedometer 06 of the existing panel 05 (in front of or obliquely corresponding to it) and used to acquire the images of the speedometer. The speedometer image acquisition device can the implemented through CMOS (Complementary Metal-Oxide Semiconductor) or CCD (Charge Coupled Device).

An image converter 20 is used to convert the images acquired by speedometer image acquisition device 10 into digital image data.

A processor 30, with image processing and judgment capability, is used to receive digital image data from the image converter 20 and to analyze the rotating angle of the pointer of speedometer 06.

A memory 40 is used to store the program of the vehicle speed warning system and digital image data of the speedometer 06.

A display screen 50 is used to display the pointer angle of speedometer and/or the judgment result of speed analyzed by the processor 30, providing a reference for the drivers. The display screen is a small graphical LCD.

A setting unit 60 is used to set the warning threshold of the pointer angle of speedometer. The setting unit is composed of some push buttons.

A warning device 70 is linked to the processor 30. When the pointer angle of speedometer 06 exceeds the warning threshold set by the driver, the warning device 70 will send a warning signal. The warning device is a loudspeaker or a buzzer, which can send music, human voice or buzzing as a symbol of warning.

The speedometer image acquisition device 10 is mounted securely in front of the speedometer 06 of the panel 05 and arranged separately or integrally with the processor 30, memory 40, display screen 50, setting unit 60 and warning device 70.

Referring to FIGS. 1 and 2, said vehicle speed warning method of the present invention is:
mounting a speedometer image acquisition device 10 correspondingly to the speedometer 06 of the existing panel 05 and acquiring images of the speedometer 06;
converting the images acquired by the speedometer image acquisition device 10 by an image converter 20 into digital image data for output;
using a processor 30 to receive the digital image data output by the image converter 20, then processing and judging the images, the pointer angle of the speedometer 06 being analyzed;
storing the program of the vehicle speed warning system and digital image data of the speedometer in a memory 40;
displaying, on a display screen 50, the pointer angle of speedometer and/or the judgment result of speed analyzed by the processor 30;
setting said warning threshold of the pointer angle of speedometer 06 by a setting unit 60; and
sending a warning signal when the pointer angle of speedometer 06 exceeds the warning threshold set by the driver.

The operating principle of the present invention is described below (referring to FIGS. 1 and 2).

When a car is running along a common road or highway, the position or rotating angle of the pointer 07 of speedometer 06 on the panel 05 can reflect the running speed in real-time. So, the speedometer image acquisition device 10 of the present invention is used to acquire the images of speedometer 06 of the panel 05, and the processor 30 is used for image analysis. In fact, the rotating speed of pointer 07 of the speedometer 06 is not very quick, and the vehicle speed warning system A does not need a very quick response. Thus, the speed set by the driver can be judged by acquiring the images of speedometer every 0.5 s or 1 s.

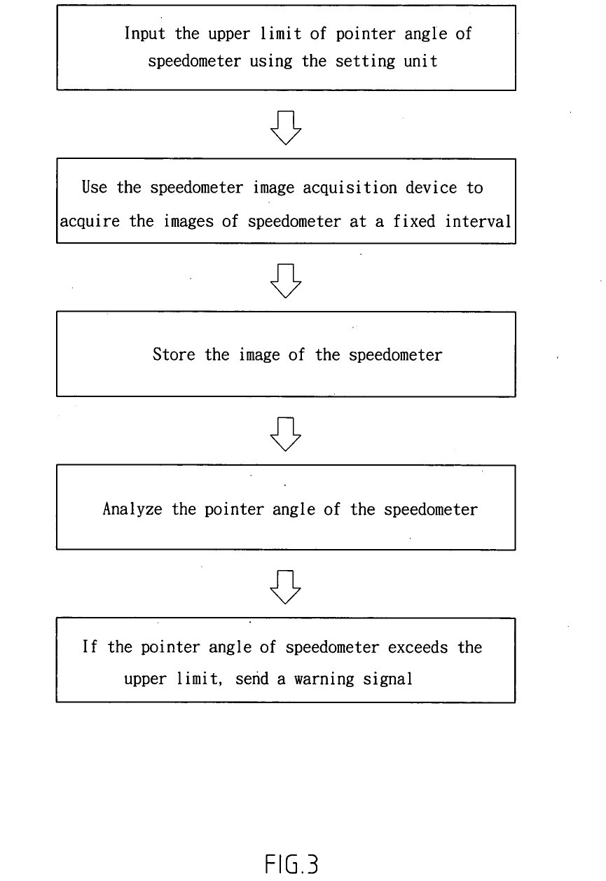

The present invention proposes a method of judging the vehicle speed by analyzing the rotating angle of the pointer of speedometer, as shown in FIG. 3. The driver can input the upper limit of a pointer angle of the speedometer using the setting unit, applying the speedometer image acquisition device to acquire the images of speedometer at a fixed interval (0.5 s or 1 s), and converting the images into digital image data and store in the memory. Then, the pointer angle of the speedometer is analyzed. If the pointer angle of speedometer exceeds the upper limit set by the driver, the warning device will send a warning signal. Owing to different scales of the speedometers specific to different vehicles, the rotating angle of the pointer of speedometer is not actually proportional to the actual speed, so the driver must compare the upper limit of pointer angle of speedometer set by the driver with the actual speed, then analyze them and adjust the setting of pointer angle according to the warning signals sent by the system. If image identification technology is used to identify the scale and positions in the speedometer, the actual speed can be calculated accordingly. However, identification of the scales requires very complex image identification algorithm, so a high-performance micro-processor and a high-capacity memory are required, leading to sharp increase of manufacturing cost. For this reason, the present invention only proposes a method of judging the vehicle speed by analyzing the rotating angle of the pointer of speedometer.

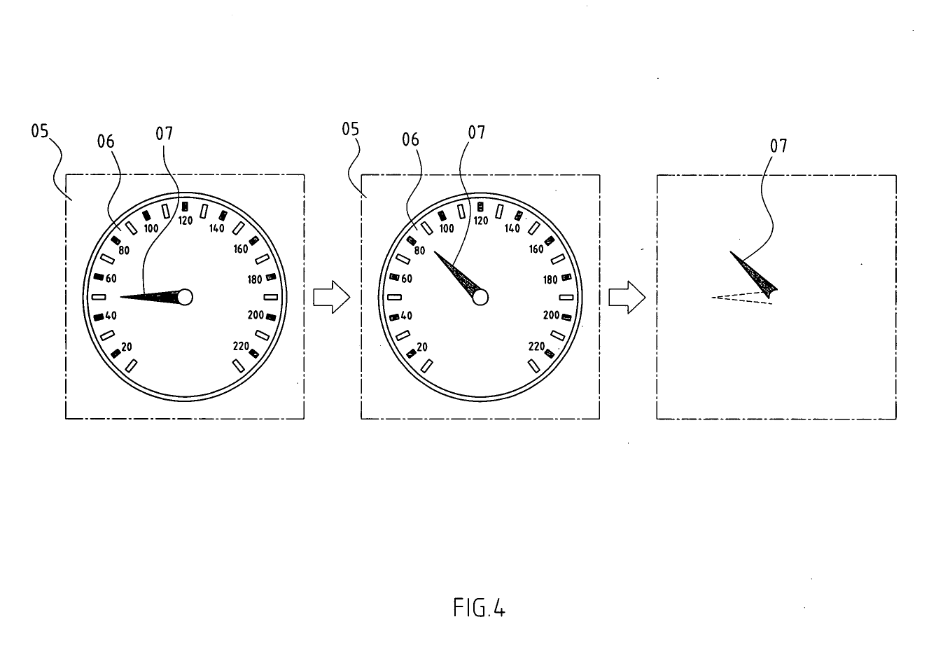

FIG. 4 depicts the other preferred embodiment of judging the pointer angle of the speedometer. As the speedometer image acquisition device is fixed to acquire the images of speedometer, the other imaging parts remain unchanged apart from the rotating pointer 07 of speedometer 06; so the newly acquired images of speedometer may subtract the previously grayed images of speedometer; if the pointer 07 of the speedometer 06 does not rotate, the subtracted result is 0, the vehicle speed is judged as not changed. Otherwise, the subtracted result shows two pointer images, one is a positive value, and the other is a negative value; the angle calculated from the positive and negative pointer images represents the latest or previous pointer angle, one of which is the same with the previous angle of positive or negative pointer image. It represents the previous pointer angle if the same, otherwise the latest pointer angle. If the latest pointer angle is smaller than the previous one, the running speed is slowed down, otherwise, increased. If the latest pointer angle is bigger than the upper limit set by the driver, a warning signal will be sent.

Additionally, with introduction of mature image identification technology, the judgment method of the present invention can also be applied to LCD speedometer by reading and judging the digital speed changes on the speedometer.

1. A vehicle speed warning system for acquiring images of a speedometer, the system comprising:
a speedometer image acquisition means, being mounted and used to acquire the images of the speedometer;
an image converter means to convert the images acquired by said speedometer image acquisition device into digital image data;
a processor means with image processing and judgment capability to receive said digital image data from the image converter, analyzing a rotating angle of said speedometer; or digital changes of said speedometer;
a memory means to store a program and digital image data of said speedometer;
a display screen means to display speed value or judgment result or both analyzed by the processor means;
a setting unit setting warning threshold of the pointer angle of speedometer; and
a warning means, being linked to the processor means, when the pointer angle of said speedometer exceeds a warning threshold set by a driver, a warning device sending a warning signal.

2. The system defined in claim 1, wherein the speedometer image acquisition device implements through CMOS (Complementary Metal-Oxide Semiconductor) or CCD (Charge Coupled Device).

3. The system defined in claim 1, wherein said warning means comprises a loudspeaker or a buzzer.

4. A vehicle speed warning method for acquiring images of a speedometer, comprising:
mounting a speedometer image acquisition device corresponding to the speedometer of an existing panel and acquiring images of the speedometer;
converting the images acquired by the speedometer image acquisition device into digital image data for output using an image converter;
receiving digital image data from the image converter, processing and judging the images, and analyzing a rotating angle of the pointer of said speedometer or digital changes of speedometer using a processor;
storing a program of a vehicle speed warning system and digital image data of the speedometer in a memory;
displaying said pointer angle of the speedometer or judgment result of speed analyzed by the processor or both, using a display screen;
setting warning thresholds of pointer angles or digital changes of speedometer by a setting unit; and
sending a warning signal, when said pointer angle of the speedometer exceeds a warning threshold.
